(19) United States
(12) Patent Application Publication
(10) Pub. No.: US 2021/0282317 A1
(43) Pub. Date: Sep. 16, 2021

(54) AGRICULTURAL APPARATUS COMPRISING HEIGHT SENSORS, AND RELATED METHODS

(71) Applicant: AGCO International GmbH, Neuhausen (CH)

(72) Inventors: Johannes Fillep, Feucht (DE); Ronnie Kinast, Ilschwang (DE)

(21) Appl. No.: 17/199,264

(22) Filed: Mar. 11, 2021

(30) Foreign Application Priority Data
Mar. 11, 2020 (GB) 2003486.4

(51) Int. Cl. A01D 34/00; A01D 57/20; A01D 75/30

(52) U.S. Cl. CPC A01D 34/008; A01D 75/303; A01D 57/20

(57) ABSTRACT

An agricultural apparatus including an agricultural vehicle together with a front work unit and two lateral work units located behind and to the sides of the front work unit. The front work unit has a connection to the front of the agricultural vehicle and the lateral work units share a connection to the rear of the agricultural vehicle. Each of the work units deposits a cut crop as a swath. One or more sensors determine a height of the deposited swath(es). A control unit controls a height of the connections above a ground surface such that if the height of one or more swathes is determined to exceed a predetermined value, the control unit causes the height of the rear connection to be raised.

### CROSS REFERENCE TO RELATED APPLICATION

This application claims the benefit of the filing date of U.K. Application No. GB2003486.4, “Agricultural Apparatus,” filed Mar. 11, 2020, which is hereby incorporated by reference in its entirety.

### TECHNICAL FIELD

The present disclosure relates to an agricultural apparatus comprising an agricultural vehicle and a number of work units suitable for generating swathes of cut crop, and in particular to a mowing apparatus for cutting a standing crop such as hay.

### BACKGROUND

It is known to provide a mower combination in which a first mower unit is located ahead of an agricultural vehicle such as a tractor with two further mower units trailing the agricultural vehicle. The rear mower units may be provided with conveyors for depositing cut crop into a swath or swathes behind the agricultural vehicle. When turning, the mower units are raised from a working position to a raised headland position. The intent is that the mower units are raised above the swath or swathes such that the mower units do not disturb the cut crop as the mower units are moved over the swath or swathes. However, in certain cases, due to the high mass yields of the cut crop, the swath or swathes of cut crop produced may be so high that moving over the swath or swathes with the mower units in the headland position is no longer possible without causing damage to the swath or swathes of cut crop. It would be beneficial to avoid damaging the swath or swathes with the mower units.

### BRIEF SUMMARY

According to a first embodiment, an agricultural apparatus comprises an agricultural vehicle together with a front work unit and two lateral work units located behind and to the sides of the front work unit, the front work unit having a connection to the front of the agricultural vehicle and the lateral work units sharing a connection to the rear of the agricultural vehicle, each of the work units depositing a cut crop as a swath, one or more sensors for determining a height of one or more of the deposited swath(es), a control unit for controlling the height of the connections above a ground surface. If the height of one or more of the deposited swath(es) is determined to exceed a predetermined value, the control unit causes the height of the rear connection to be raised.

The agricultural apparatus may include a further sensor to detect the presence of crop ahead of the front work unit and if no crop is detected, the control unit causes one or more of the work units to move from the working position to the headland position.

According to another embodiment, a method of operation of an agricultural apparatus comprises providing a predetermined set of values to the control unit, monitoring the height of one or more deposited swath(es) by providing signals representative of the height of the one or more deposited swath(es), the control unit comparing the signals representing the height of the one or more deposited swath(es) against a predetermined set of values and if indicated, signaling at least the rear connection to be raised or lowered based on the comparison.

The method may also include monitoring for the presence of standing crop ahead of the agricultural vehicle, and if no crop is detected, the control unit causes one or more of the work units to move from a working position to a headland position.

According to another embodiment, a computer implemented method comprises a control unit receiving a plurality of signals, the signals representing the height of at least a first swath deposited by the work units, the control unit being configured to receive the plurality of signals and compare the signals for the height of at least the first swath deposited by the work units against a predetermined set of values and if indicated, generating a signal to cause the position of the rear connection to be adjusted based on the comparison.

The method may also include monitoring for the presence of standing crop ahead of the agricultural vehicle, and if no crop is detected, the control unit causing one or more of the work units to move from the working position to the headland position.

According to another embodiment, a computer readable storage medium comprises instructions that cause one or more processors to implement the methods described herein.

### BRIEF DESCRIPTION OF THE DRAWINGS

Embodiments will now be described, by way of example only, with reference to the accompanying drawings, in which:

FIG. 1 shows a plan view of an agricultural apparatus;

FIG. 2 shows a schematic view of elements of an agricultural apparatus;

FIG. 3 shows a schematic side view of a portion of an agricultural apparatus having lateral work units illustrating a problem with conventional configurations;

FIG. 4 shows a schematic side view of a portion of an agricultural apparatus provided with lateral work units;

FIG. 5 shows a flow diagram in relation to a first operation of the agricultural apparatus; and

FIG. 6 shows a flow diagram in relation to a further operation of the agricultural apparatus.

### DETAILED DESCRIPTION

The disclosure will now be described in the following detailed description with reference to the drawings, wherein certain embodiments are described in detail. Although described with reference to these specific embodiments, it will be understood that the disclosure is not limited to these embodiments. But to the contrary, numerous alternatives, modifications, and equivalents will become apparent from consideration of the following detailed description.

Reference to terms such as longitudinal, transverse, and vertical are made with respect to a longitudinal vehicle axis, which is parallel to a normal forward direction of travel.

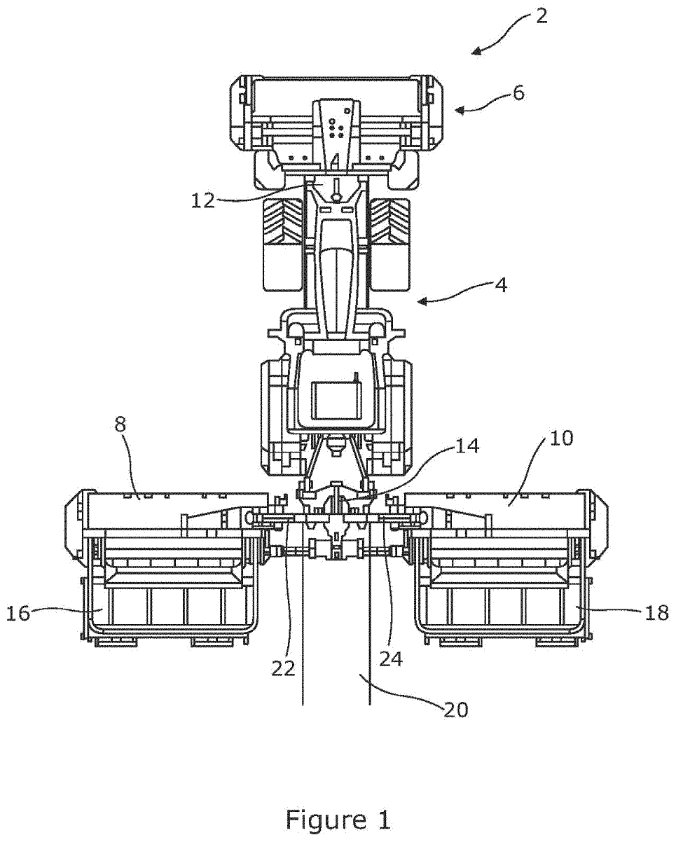

With reference to FIG. 1, a plan view of an agricultural apparatus 2 is shown. The agricultural apparatus 2 comprises an agricultural vehicle 4 such as a tractor and a number of work units 6, 8, 10 suitable for cutting standing crop, the work units 6, 8, 10 being connected to the agricultural vehicle 4. The work units 6, 8, 10 include a front work unit 6 located to the front of the agricultural vehicle 4 and two lateral work units 8, 10 located behind and to the sides of the front work unit 6, each of the work units 6, 8, 10 depositing cut crop as a swath. The front work unit 6 is conveniently mounted on a front hitch 12 of the agricultural vehicle 4. In some embodiments the work units comprise mowing units.

The lateral work units 8, 10 are supported from a central chassis by lifting units, for example hydraulic units 22, 24. Each hydraulic unit 22, 24 may be used to move a respective lateral work unit 8, 10 between a working position and a transport position. A headland position may be defined between the working position and the transport position. In the working position, the height of each of the lateral work units 8, 10 above a ground surface 21 may be further controlled by operation of the hydraulic units 22, 24 between minimum and maximum displacement values—that is, across a ground adaptation range.

In FIG. 1, a swath 20 produced by the front work unit 6 is shown. In FIG. 1 conveyors 16, 18 mounted to the rear of the lateral work units 8, 10 direct cut crop inwardly to produce a broader central swath 20. These swathes are omitted from FIG. 1 for clarity.

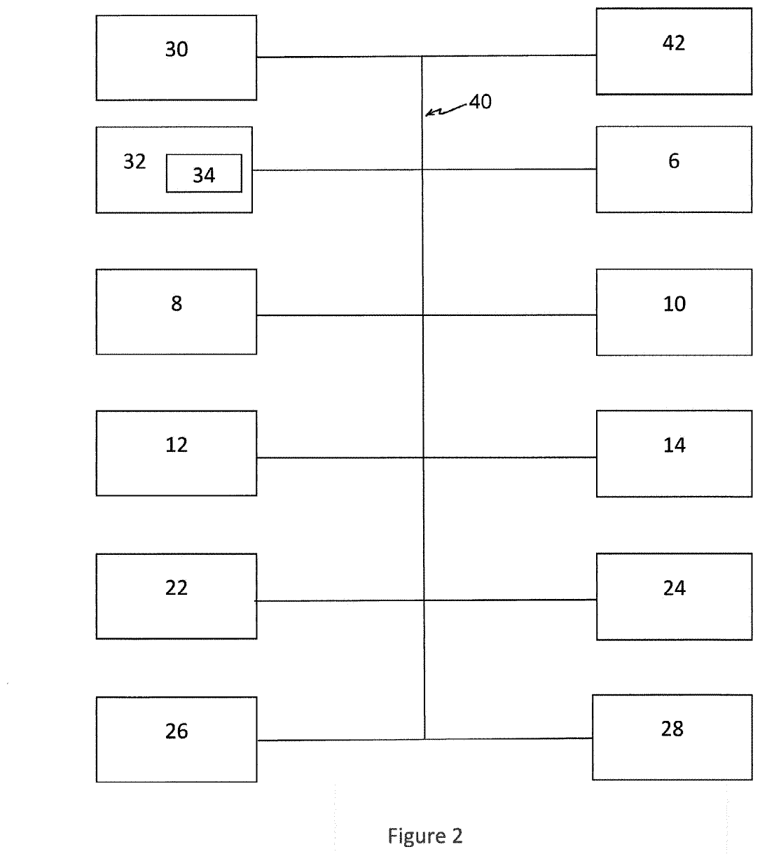

A sensor 26 (FIG. 2) is provided to determine a displacement or position 50 of the rear hitch 14—that is, the relative position of the rear hitch 14 in relation to a reference position on the agricultural vehicle 4 (FIG. 4).

An operator can control operation of the front and rear work units 6, 8, 10 from within the agricultural vehicle 4 by use of a suitable user terminal 30. For example, the operator can cause each of the work units to move about the central frame from a working position to a headland position and can cause each of the lateral work units 8, 10 to move between the working position and the transport position. As noted above, the operator can also control the working height of the lateral work units 8, 10 within the ground adaptation range by use of the hydraulic units 22, 24.

The user terminal 30 communicates with an electronic control unit 32. The control unit 32 provides signals to control operation of the front and rear hitches 12, 14 of the agricultural vehicle 4 and provides signals to control operation of the work units 6, 8, 10 and the conveyor units 16, 18. Conveniently, the signals are provided by way of a suitable data communication network 40 such as one compliant with the ISOBUS standard (a network in conformance to ISO 11783).

The control unit 32 may comprise a single processor located on the agricultural vehicle, or its functions may be split between a processor located on the agricultural vehicle and one or more additional processors located on the work units 6, 8, 10, the additional processor(s) being in electronic communication with the first processor.

The control unit 32 is also able to access a suitable memory 34. The memory 34 may take any suitable form and is in electronic communication with the control unit 32.

A sensor 28 provides a signal representative of a height 27 of the deposited swath 20. The sensor 28 may be located on the front work unit 6 or on the agricultural vehicle 4 as is convenient. The sensor 28 is in electronic communication with the control unit 32. The sensor 28 may be used to determine the height 27 of the deposited swath 20 before the operator executes a headland operation with the agricultural apparatus 2.

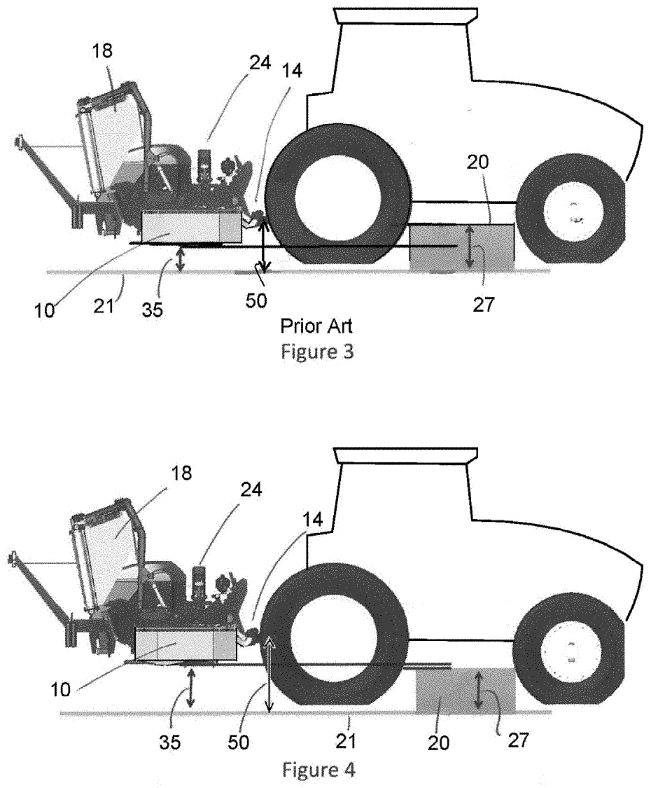

FIG. 3 illustrates a known problem with the state of the art. At high mass yields of a standing crop, the swath 20 of cut crop produced may be so high that moving the lateral work units 8, 10 over the swath 20 in the headland position may not be possible without causing damage to the swath 20 since the raised height 35 of the lateral work units 8, 10 is less than the height 27 of the swath 20.

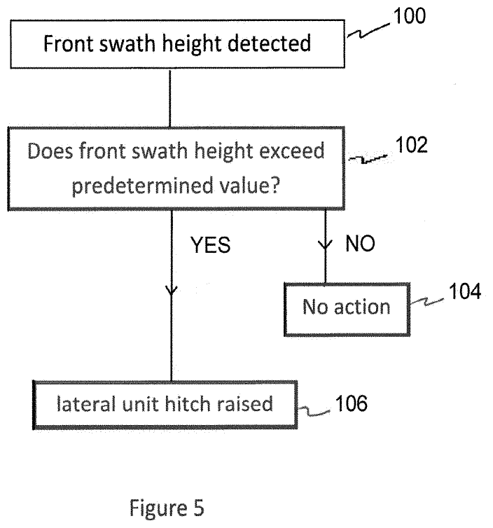

FIGS. 4 and 5 illustrate a method of addressing this problem. The height 27 of the swath is detected (act 100 in FIG. 5) and a signal sent to the control unit 32. The control unit 32 compares the height 27 to a predetermined value (act 102). The predetermined value is stored in the memory 34 in any suitable manner, such as a database or look-up table. The predetermined value corresponds to the normal operating height of the lateral work units 8, 10 when in a headland position. If the value of the height 27 of the swath is less than the predetermined value, the control unit 32 takes no further action (act 104). If the value of the height of the swath is equal to or greater than the predetermined value, the control unit 32 causes the rear hitch 14 of the agricultural vehicle to be raised (act 106), thereby raising the lateral work units 8, 10 such that the lateral work units 8, 10 do not damage the swath 20 of cut crop.

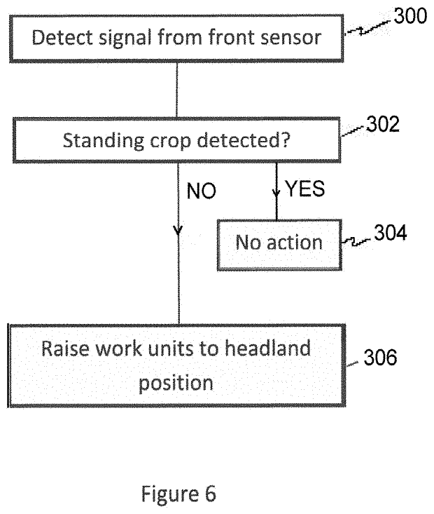

In a further embodiment, a front sensor 42 detects the presence or absence of standing crop ahead of the agricultural apparatus 2. This front sensor 42 may be mounted on the agricultural vehicle 4 or on the front work unit 6. Alternatively an aggregated signal from sensors 42 on both the agricultural vehicle 4 and the front work unit 6 may be used. The control unit 32 detects the signal from the front sensor 42 (act 300 in FIG. 6) and determines the presence or absence of standing crop ahead of the front work unit 6 (act 302).

If standing crop is detected, the control unit 32 takes no action, and the work units 6, 8, 10 continue to operate in the working position (304). If no standing crop is detected, the control unit 32 causes the work units 6, 8, 10 to move to the headland positions (act 306). Thus, when the edge of the standing crop to be processed is reached, the agricultural apparatus reaches the headland position as soon as possible.

By monitoring the speed of the agricultural vehicle 4, the front work unit 6 may first be moved to a headland position and the lateral work units 8, 10 may be subsequently controlled to continue cutting the standing crop until the edge of the standing crop is reached; then the lateral work units 8, 10 also are automatically raised to their headland position.

Still other embodiments involve a computer-readable storage medium (e.g., a non-transitory computer-readable storage medium) having processor-executable instructions configured to implement one or more of the techniques presented herein. Many such computer-readable media may be devised by those of ordinary skill in the art that are configured to operate in accordance with one or more of the techniques presented herein.

From reading the present disclosure, other modifications will be apparent to persons skilled in the art. Such modifications may involve other features which are already known in the field of mowers and component parts therefore and which may be used instead of or in addition to features already described herein.

1. An agricultural apparatus comprising:
an agricultural vehicle coupled to a front work unit and two lateral work units located behind and to the sides of the front work unit, the front work unit having a connection to a front of the agricultural vehicle and the lateral work units sharing a connection to a rear of the agricultural vehicle, each of the work units configured to deposit a cut crop as at least one swath;
at least one sensor configured to sense a height of the at least one swath; and
a control unit configured to control a height of the front and rear connections above a ground surface, wherein the control unit causes the height of the rear connection to be raised if the height of the at least one swath is determined to exceed a predetermined value.

2. The agricultural apparatus of claim 1, further comprising another sensor configured to detect the presence of crop ahead of the front work unit, wherein the control unit is configured to cause at least one of the work units to move from a working position to a headland position when no crop is detected by the another sensor.

3. A method of operating an agricultural apparatus, wherein the agricultural apparatus comprises:
an agricultural vehicle coupled to a front work unit and two lateral work units located behind and to the sides of the front work unit, the front work unit having a connection to a front of the agricultural vehicle and the lateral work units sharing a connection to a rear of the agricultural vehicle, each of the work units configured to deposit a cut crop as at least one swath;
at least one sensor configured to sense a height of the at least one swath; and
a control unit;
the method comprising:
providing a predetermined set of values to the control unit;
monitoring the height of the at least one swath by providing at least one signal representative of the height of the at least one swath to the control unit;
the control unit comparing the at least one signal to the predetermined set of values; and
the control unit causing the height of the rear connection to be adjusted when indicated by the comparison.

4. The method of claim 3, further comprising:
monitoring for standing crop ahead of the agricultural vehicle; and
the control unit causing at least one of the work units to move from a working position to a headland position when no crop is detected.

5. A computer implemented method comprising:
a control unit receiving a plurality of signals, the signals representing heights of at least a first swath deposited by work units;
the control unit comparing the received signals to a predetermined set of values; and
the control unit generating a signal to cause the height of the rear connection to be adjusted when indicated by the comparison.

6. The computer implemented method of claim 5, further comprising:
monitoring for standing crop ahead of the agricultural vehicle; and
the control unit causing at least one work unit to move from a working position to a headland position when no crop is detected.

7. A computer readable storage medium comprising instructions that cause at least one processor to implement the method of claim 5.

8. A computer readable storage medium comprising instructions that cause at least one processor to implement the method of claim 6.
